(19) United States
(12) Patent Application Publication
(10) Pub. No.: US 2016/0132923 A1
(43) Pub. Date: May 12, 2016

(54) System of using high throughput studies to guide research and marketing

(71) Applicant: Yunguang Tong, Tucson, AZ (US)

(72) Inventor: Yunguang Tong, Tucson, AZ (US)

(21) Appl. No.: 14/470,722

(22) Filed: Aug. 27, 2014

(51) Int. Cl. G06Q 30/02; G06F 17/30

(52) U.S. Cl. CPC G06Q 30/0251; G06F 17/30395; G06F 17/30557

(57) ABSTRACT

The present invention relates to methods, systems, and apparatus for storing, managing, searching and presenting large-scale data derived from high-throughput experiments. It provides a highly efficient platform for researchers, statisticians and venders to interact.

### 1. BACKGROUND OF THE INVENTION

1.1. Field of the Invention

This invention is related to storage, management, search and displaying results derived from high throughput experiments.

1.2. Description of the Related Technology

The advance of technologies allows performing a large amount of detection simultaneously, which generate a large amount of detection results, also called raw data. For example, microarray technology allows examine status of more than 20,000 genes with a Chip. Next Generation Sequencing (NGS) technology further increases the throughput, which generates millions or even billions of reads (short sequence information) in a few days. The advance of high throughput technologies challenges current methods of data storage, management, search and displaying.

The detection results (Raw data) are analyzed to determine the quality of detection and strength of signal. By combining the detection results and experimental factors, a researcher can analyze the experiment and obtain experimental result of detection.

There are two major systems (GEO and ArrayExpress) to manage and store microarray raw data and detection results. Standard data format has been proposed to store detection results derived from microarray studies. However, there are lacking a robust system to store, manage, search and display the experimental results derived from these high throughput experiments. GEO and ArrayExpress are mainly targeted at storing detection results from microarray experiments. The only function related to experimental results storage and management in GEO system is GEO profiles (http://www.ncbi.nlm.nih.gov/geoprofiles/). A researcher can search profile of a specific gene that exists in these microarray experiments. However, GEO did not provide fold change, or p-value of the specific gene, which is critical for a scientist to determine whether the information is scientifically meaningful. ArrayExpress host a Gene Expression Atlas database (http://www.ebi.ac.uk/gxa/), which allows user to search whether a gene is up or down regulated in certain experimental conditions. ArrayExpress presents a p-value in the results, but not fold change.

Oncomine and NextBio are two systems focusing on managing results derived from high throughput studies. Oncomine (http://www.oncomine.org/) is a system to store and manage experimental results derived from microarray experiments related to cancer. It presents a way to store results derived from both gene expression and DNA copy number studies. NextBio (http://www.nextbio.com) is a similar platform, which allow enterprise user to upload private results and integrate these results with public results derived from high-throughput experiments. In patents US 2007/0162411 (System and method for scientific information knowledge management), US 2009/0049019 (Directional expression-based scientific information knowledge management), US 2009/0222400 (Categorization and filtering of scientific data), US 2010/0318528 (Sequence-centric scientific information management), Kupershmidt et al claimed some rights to use computer-implemented methods to store and manage the features extracted from high-throughput biological or chemical arrays.

Although these systems help uses to manage the experimental results, none of them clearly delineate the analysis procedure of each experiment and provide details of how the data is analyzed, which is critical for researchers to judge the quality of the analysis and detailed results. None of these systems allows researchers to purchase individual report or selected detailed results. Also, none of these systems use the experimental results to guide vender for marketing. Finally, none of these systems allow interaction of Statistician, Researcher and Vendor.

### 2. SUMMARY OF THE INVENTION

Here I invented a system, which provides a new solution for managing experimental results derived high throughput experiments. It has novel features: 1) structured storage of information for studies, analyses and reports; 2) a faceted search interface that enable a biologist to identify important information of an experimental result. I also invented 3 novel business models for such a system 1) a sale module to retail experimental results; 2) a advertising module that enable a vender to attach advertisement to the experimental results; 3) a marketing module that enable a vender to provide sponsorship to a researcher to help the researcher to gain access to the experimental results.

An aspect of this invention is to allow Statisticians, Researchers and Vendors to interact in a web-based system.

Another aspect of this invention is to allow Statisticians to provide service and/or results of analysis to Researchers through a web-based system.

Another aspect of this invention is to use results derived from high-throughput experiments to guide marketing.

Another aspect of this invention is to allow Vendors to provide related product information to Researchers, so that Researchers can buy these products is to validate the results derived from high-throughput experiments.

Another aspect of this invention is to store analysis of high-throughput studies so that each analysis can be used by multiple users.

These and other advantages of one or more aspects will become apparent from a consideration of the ensuing description and accompanying drawings.

### 3. DESCRIPTION OF THE DRAWING

FIG. 1A is an exemplary embodiment of workflow and information storage system according to the present invention. FIG. 1A outlines the representative elements of the workflow and information storage system.

FIG. 1B is an exemplary embodiment of business logic depicting how users of different roles do business in the system.

FIG. 2A is an exemplary embodiment of information fields of the elements according to the present invention.

FIG. 2B is an exemplary embodiment of input interface for study. This input interface provide input field to collect information related to study.

FIG. 2C is an exemplary embodiment of input interface for study (continue of FIG. 2B). This input interface provides additional field to collect information for study.

FIG. 2D is an exemplary embodiment of input interface for analysis. This input interface provide input field to collect information related to analysis.

FIG. 2E is an exemplary embodiment of input interface for report. This input interface provide input field to collect information related to report.

FIG. 2F is an exemplary embodiment of input interface for detailed result of report (genedata).

FIG. 2G is an exemplary embodiment of display interface for study. This interface displays information pertain to study, including information of study, analysis performed for the study and corresponding results.

FIG. 2H is an exemplary embodiment of display interface for analysis. This interface displays information pertain to analysis, including information of the analysis, results of the analysis and the related study.

FIG. 2I is an exemplary embodiment of display interface for report.

FIG. 2J is an exemplary embodiment of display interface for detailed result of report (genedata).

FIG. 2K an exemplary embodiment of categories of faceted classification.

FIG. 3A is an exemplary embodiment of advertisement module according to present invention.

FIG. 3B is an exemplary embodiment of input interface for advertisement.

FIG. 3C is an exemplary embodiment of input interface for common names.

FIG. 3D is an exemplary embodiment of display interface for common names and advertisement.

FIG. 4A is an exemplary embodiment of sponsorship module according to the present invention.

FIG. 4B is an exemplary embodiment of input interface for sponsorship. This interface collects information of sponsorship.

FIG. 4C is an exemplary embodiment of display interface for sponsorship. This interface display information pertain to sponsorship.

FIG. 4D is an exemplary embodiment of interface for sponsorship offer. This interface display a sponsorship offer to a user.

FIG. 4E is an exemplary embodiment of pay by self workflow.

FIG. 4F is an exemplary embodiment of pay by sponsor workflow.

FIG. 5A is an exemplary embodiment of index structure for faceted search.

FIG. 5B is an exemplary embodiment of faceted interface according to the present invention.

FIG. 5C is an schematic representation of faceted search interface.

FIG. 5D is another schematic representation of faceted search interface.

### 4. DETAILED DESCRIPTION OF THE INVENTION

The present invention may involve novel message formats, apparatus and data structures for facilitated managing and searching experimental results. The following description is presented to enable one skilled in the art to make and use the invention, and is provided in the context of particular applications and their requirements. Various modifications to the disclosed embodiments will be apparent to those skilled in the art, and the general principles set forth below may be applied to other embodiments and applications. Thus, the present invention is not intended to be limited to the embodiments shown and the inventors regard their invention as any patentable subject matter described.

The experimental results mentioned in the present invention includes, but not limited to results derived from biological high throughput experiments.

It is to be understood that the system can be implemented using general purpose computer hardware as a network site. The general purpose hardware may advantageously be in the form of a Linux workstation or other suitable computer. The hardware will be configured and customized by various software modules. The software modules will include communications software of the type conventionally used for internet communication and a database management system. Any number of free or commercially available database management systems may be utilized to implement the invention. Those of ordinary skill in the art of database management application programming will be able to make and use the invention according to the disclosure hereof.

The invention may advantageously be implemented using web framework (such as Ruby on Rails, Django, CakePHP or Symfony) or content management system (such as Joomla or Drupal). The using of content management systems will make the implementation easier as these content management systems already present a complete user authentication system, a robust authorization model, a way to define any number of “Content Types”, a way to store content objects and relationships and a flexible taxonomy system that can be used to categorize and tag content.

The following terms are used throughout the specifications. The descriptions are provided to assist in understanding the specification, but do not necessarily limit the scope of the invention.

High throughput experiment—an experiment using high throughput techniques, which obtain hundreds or thousands of detection results simultaneously.

Detection Results—also called raw data. Detection results are results generated by the detection sensors.

Experimental Results—experimental results are generated by analyzing the detection results based on experimental design.

Study—the Study is defined as information of high throughput experiments, which includes, but not limited to experimental details such as experimental methods, design, platform, samples and sample size.

Analysis—the Analysis information is defined as statistical Analysis performed for the said Study. The type of analysis includes, but not limited to student T test, analysis of variance and survival analysis.

Report—the Report is defined as results of the Analysis. The information of Report includes, but not limited to, a cutoff for the analysis results, number of detailed results at specified cutoff, and a list of experiment results.

Detailed results—the detailed results belong to Report. Each report comprises detailed results which are hundreds or thousands of filtered experimental results of detections. In a typical gene expression microarray or next generation sequencing experiment, the detailed results are usually a list of differentially expressed genes.

GeneData—the alias of Detailed Results when performing microarray or Next Generation Sequencing analysis.

Common Name—detections are corresponding to common names, which could be used to represent one type of detection in multiple Studies. In the case of gene expression microarray or next generation sequencing experiment, the common name of each experimental result is usually a gene symbol of a specific gene.

Researcher—A user performs regular experiments. A researcher usually wants to look into the results derived from high throughput studies to find clues or preliminary data for a specific research.

Statistician—A user performs statistical analysis for high throughput experiments. Typical statistical analyses includes, but not limited to student t test, analysis of variance (ANOVA) and cox regression.

Vendor—A user sells experimental resources to researchers. A vendor usually wants to find out the needs of researchers so that it can sell those experimental resources, including reagent and equipment. Vendor can serve as sponsor or advertiser.

Sponsor—A user provides sponsorship, a researcher can use the sponsorship to gain access to certain access-restricted information.

Advertiser—A user wants to advertise its product.

Faceted classification—A faceted classification system allows the assignment of an object to multiple characteristics (attributes), enabling the classification to be ordered in multiple ways, rather than in a single, predetermined, taxonomic order.

Faceted search—is a technique for accessing information organized according to a faceted classification system, allowing users to explore a collection of information by applying multiple filters.

In the following, a system for data storage, management and search, and the exemplary embodiments of the present invention are described in 4.1. Then, a detailed data structure and its exemplary embodiments of the present invention are described in 4.2. An advertisement module and its exemplary embodiments of the present invention are described in 4.3. An integration of sponsorship module and its exemplary embodiments of the present invention are provided in 4.4. An index structure, a faceted search interface and its exemplary embodiments of the present invention are described in 4.5.

4.1. An Information Storage and Management System for High Throughput Studies

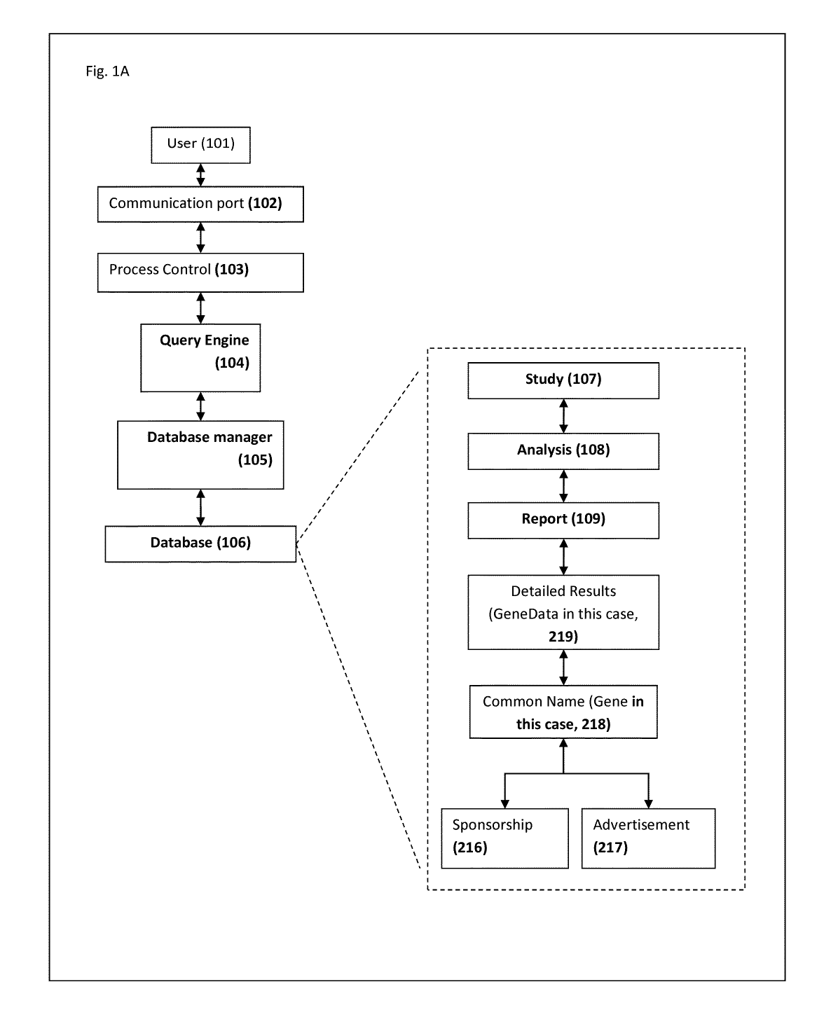

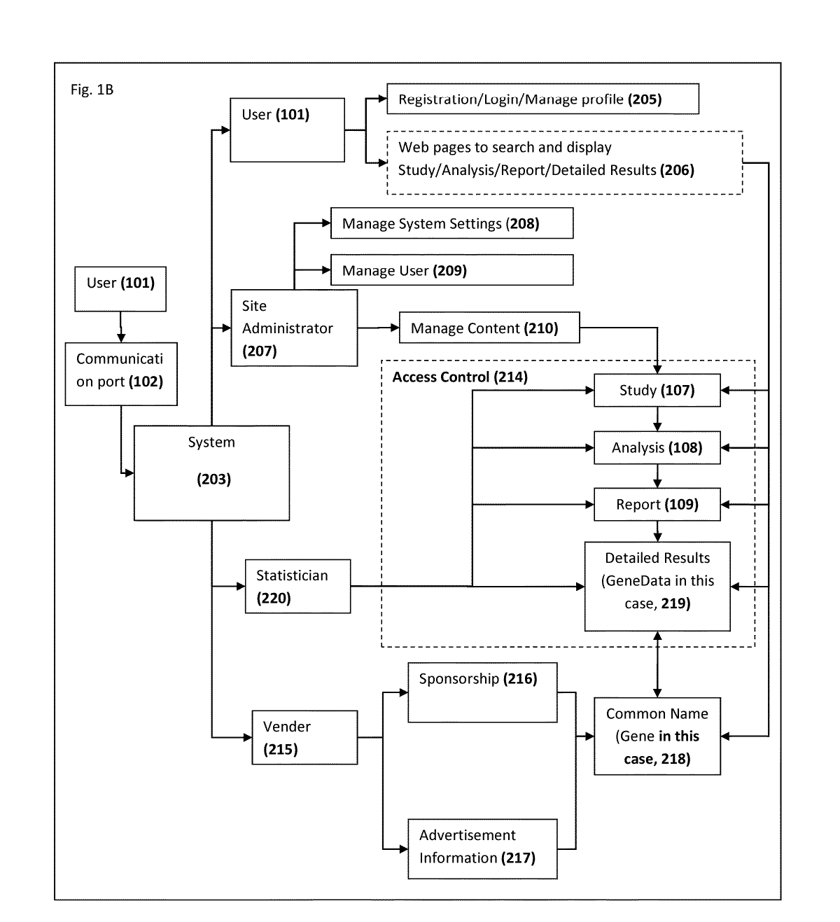

According to the embodiments (FIG. 1A and 1B), a process control unit (103) will manage the flow of information through the system. A communication port (102) is provided to allow User (101) to access the network. According to the preferred embodiment, the network may include access over the internet to any number of external computer systems or access through local or wide area network to other connected computers either directly or through modems. The system will include database memory provided to store the databases.

The bases may be in the form of a data file comprised of a plurality of records, each record corresponding to a posted item. Each record will include a number of predefined fields containing parameters and additional fields containing descriptive information of the type generally used.

A user establishing access to the system according to the invention through the communication port (101) will be presented with a variety of menus. According to the preferred embodiment, communication may be effected through hypertext markup language (html) pages, ASP, PHP, JSP or other language pages.

The process control unit (103) passes information for the fields of the specified base from the user's computer through the communication port (102) into the selected database record (106). The bases are electronically stored databases. The databases are collection of records stored in electronically readable memory. The records advantageously includes fields specifying name, and narrative fields containing descriptive information, a description of key functions, and identification of a predetermined category, a specification of term according to literature, and a description of common usage. The fields in a record may be populated through use of a form presented to the user. The records may also include fields for a user password and a field that is used to designate the record as a submission to an accessible pool.

The system also include an iterative database query engine (104) connected to the memory and a process controller connected to the database manager (105), the interactive database query engine and the communication port. The project repository records may contain a plurality of search key fields. The iterative database query engine may include means for searching on a plurality of search key fields of a database for satisfaction of one or more conditions and means for reporting all variables in said search key fields of records which satisfy the search conditions. The search key field may restrict the possible entries to a predetermined set of entries.

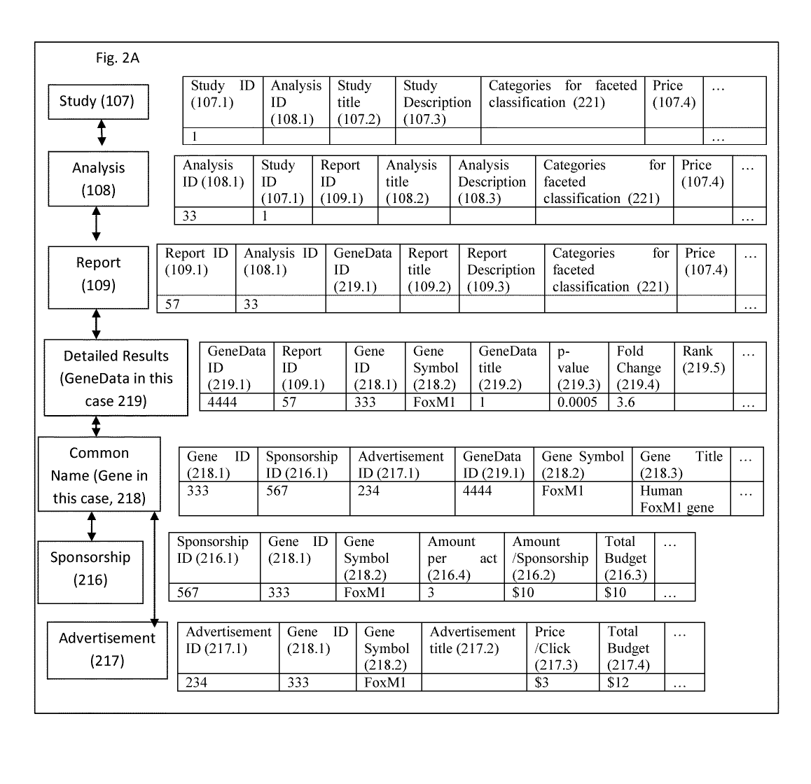

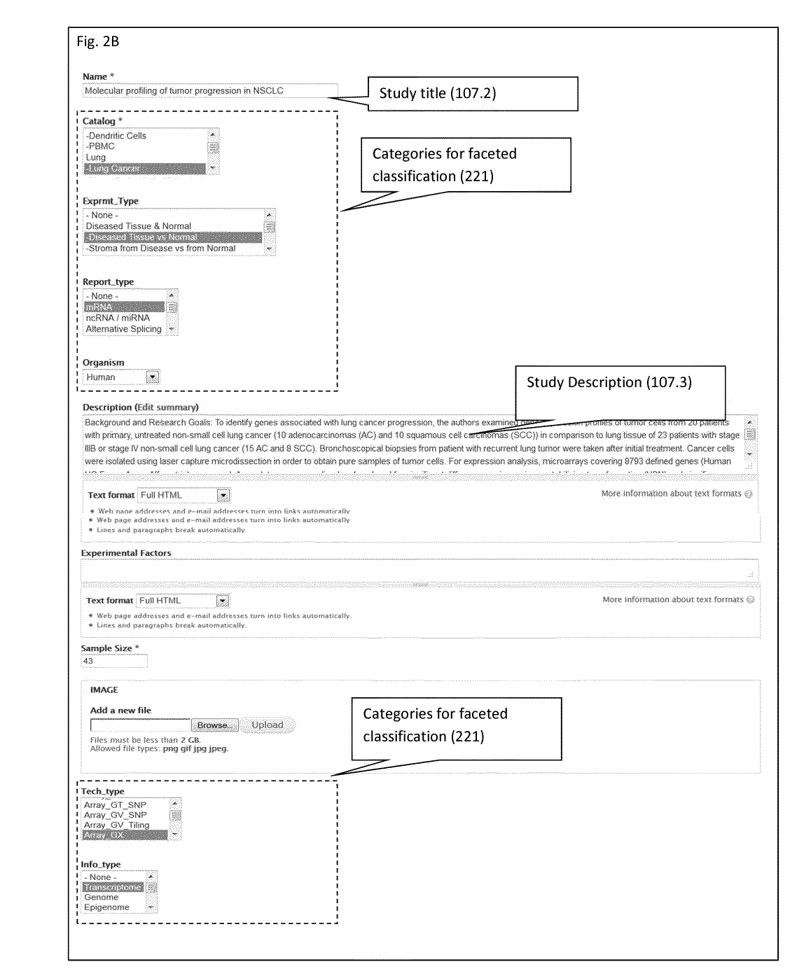

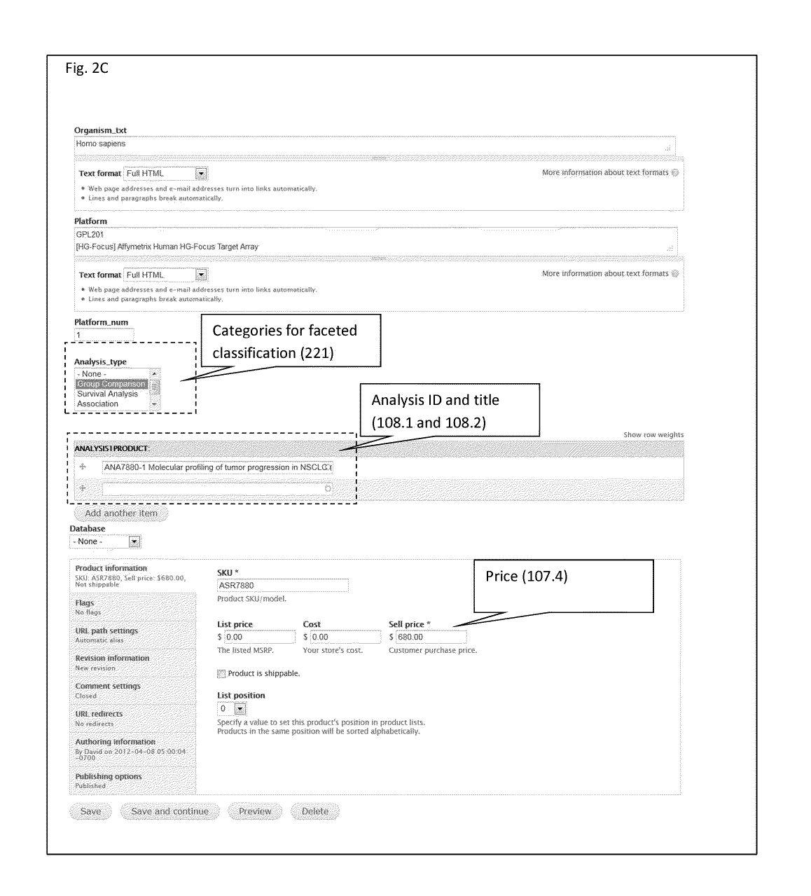

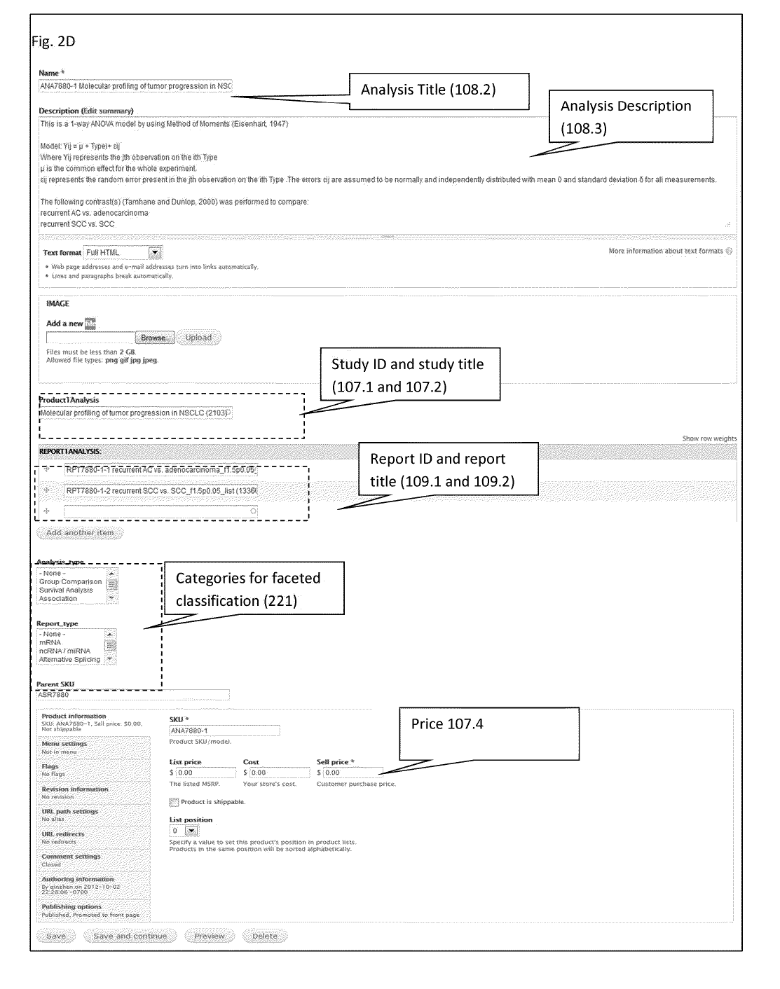

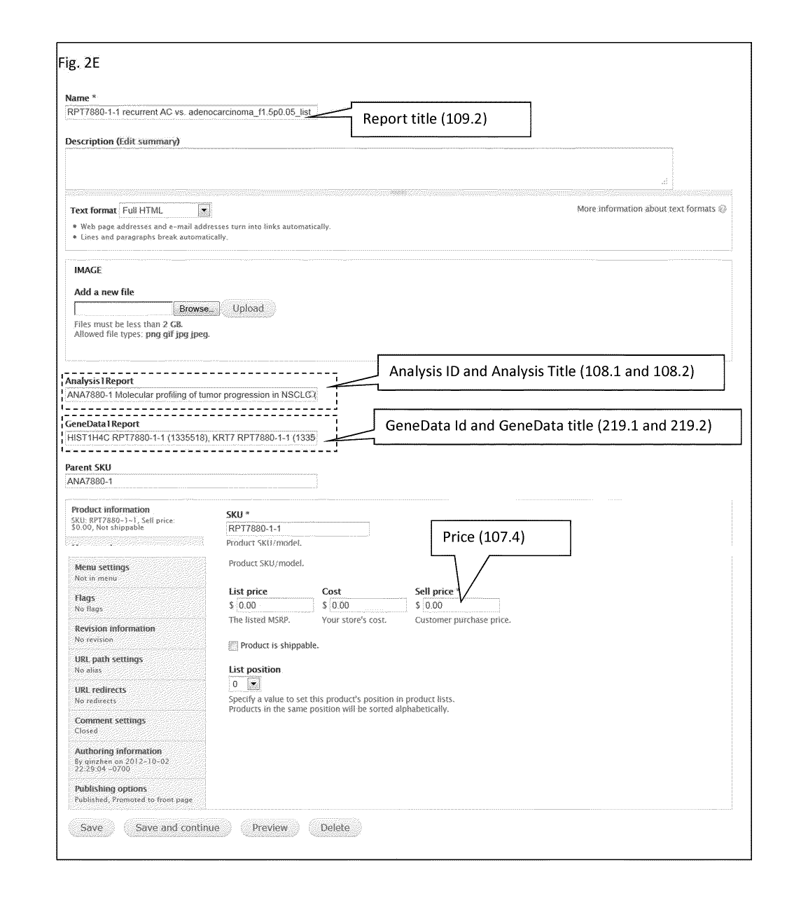

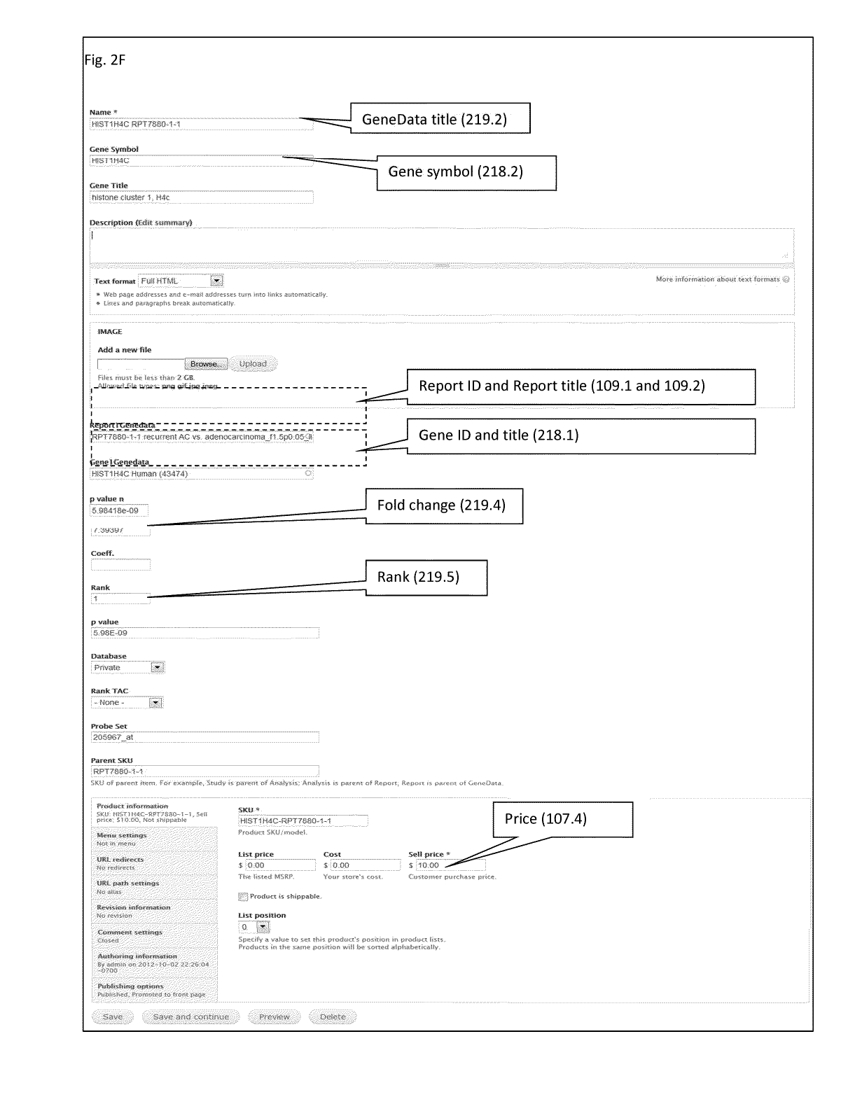

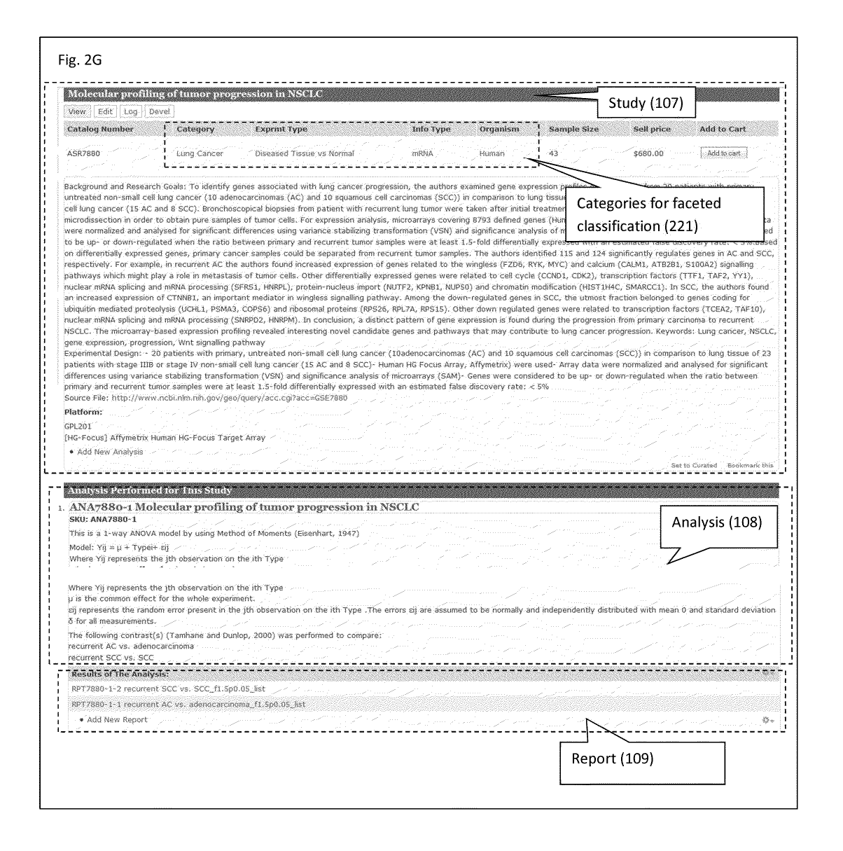

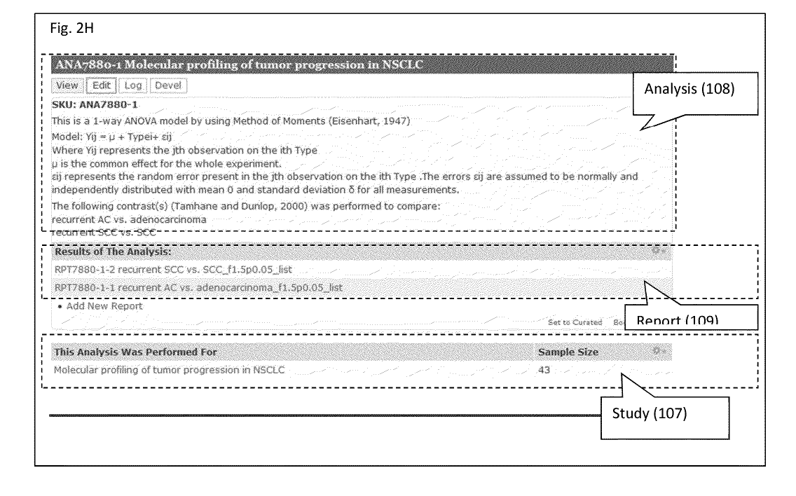

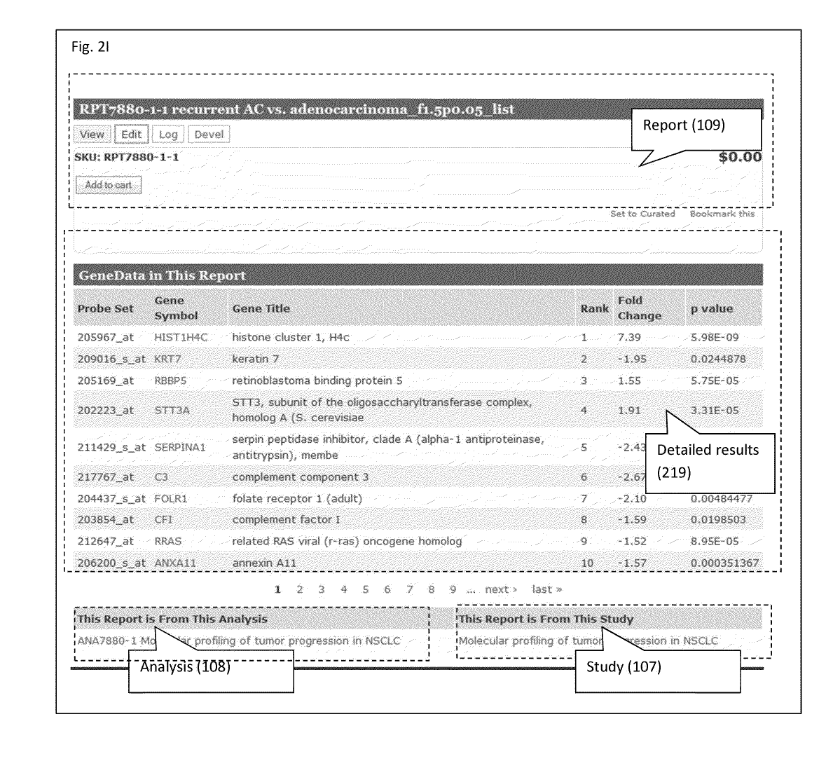

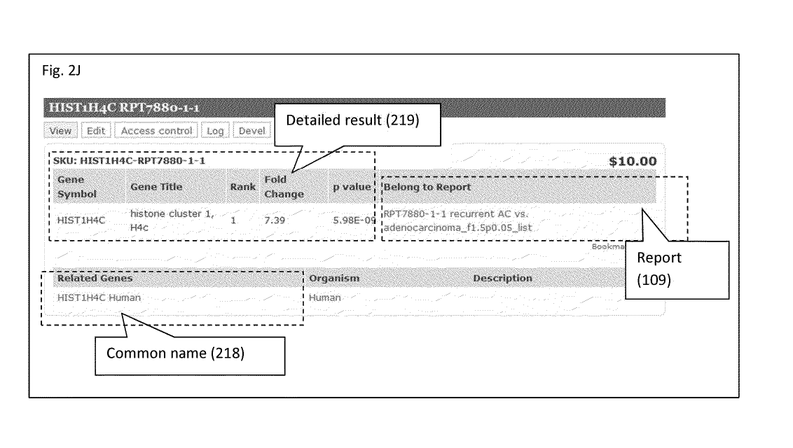

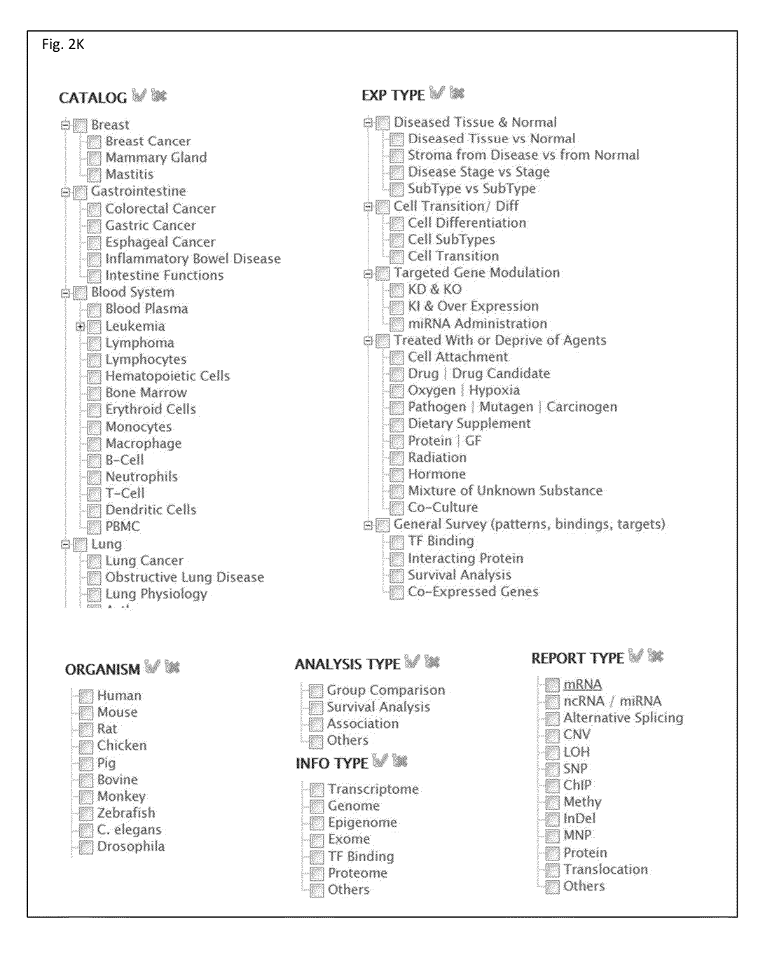

According to the present embodiment (FIG. 2A), the information stored in the database includes information of Study (107), Analysis (108), Report (109), Detailed Results (219, GeneData in this embodiment), Common Name (218, Gene Symbol of Gene in this embodiment), advertisement (217) and sponsorship (216), with each comprising a plurality of fields.

According to the present embodiment (FIG. 1B), when accessing the system (203), a user is presented with a registration form (205) by which s/he can register into different roles, which include administrator, researcher, sponsor, advertiser, vender and statistician. More roles can be created whenever needed and a user can have multiple roles. All registered users (101) can manage their own profiles after login. User will also allow searching information through a provided interface (206). The contents to be searched are records in the system database, include information about Studies (107), Analyses (performed for the study, 108), Report (derived from the analysis, 109), and GeneData (219) and Gene (218).

If a user is assigned as site administrator (207), it will be presented an administration interface, through which it can manage system settings (208) and registered members (209). A site administrator is also presented with an interface to manage content (214), including add/edit/delete/search records in the system database. The administrator will be presented with an options menu. The options menu will also include the options of submitting a Project (107), Analysis (108), Report (109), GeneData (219) or Gene (218) to the system database. The options will further include options of searching, editing and deleting the submitted records.

If a user is assigned as Statistician (220), it is presented with an interface to manage its own content, including add/edit/delete/search records in the system database. The Statistician will be presented with an options menu. The options menu will include the options of submitting a Project (107), Analysis (108), Report (109), and GeneData (219) to the system database. The options will further include options of searching, editing and deleting the submitted records.

A registered user (101) can be granted permission to submit a Project (107). A Statistician (220) can perform analysis for the submitted Project and input Analysis (108), Report (109), GeneData (219) into the database. The registered user will be grant permission to view the inputs of the Statistician under predetermined conditions.

The system further includes an access control module (214), so that some information in the database may be restricted to certain users or under certain conditions. When the information is submitted to an accessible pool; a mechanism may be provided to prevent access to the information by specified parties in order to protect private property. Access may be restricted by including a field in the data record identifying groups. These parties include but not limited to these who have premium membership or purchased access to the information.

The system further includes a Vender module (215) to allow vender to provide sponsorship (216) or advertisement (217). The sponsorship and advertisement are correlated to Gene information and will be presented to user by the system. The business logic of the vender module is further explained in follows.

4.2. An Exemplary Embodiment of Fields in Study, Analysis, Report, Detailed Results, Common Name (of Detailed Results), Sponsorship and Advertisement.

The database comprises records of Study (107), Analysis (108), Report (109), Detailed Results (219, GeneData in this embodiment), Common Name (218, Gene Symbol of Genes in this embodiment), Sponsorship (216) and Advertisement (217). Each comprises a plurality of fields. These fields serve three major functions: 1) store the relations between records; 2) categorize the records; 3) store the main information of the records.

As indicated in the embodiment FIG. 2A, the fields of the records in the system database are designed in such a way so that these records are internally correlated. Analysis (108) correlates with Study (107). Report (109) correlates with Analysis (108). GeneData (219) correlate with Report (109). Sponsorships (216) and Advertisements (217) correlate with Gene (218). The correlation is implemented by ID of each type of record, such as Study ID, Analysis ID, Report ID, GeneData ID, Gene ID, Sponsorship ID and Advertisement ID.

As shown in the embodiments FIG. 2A, a Study record (107) comprises fields for Study ID (107.1), Analysis ID (108.1), Study Title (107.2), Study description (107.3), Categories for faceted classification (221) and price (107.4). The Analysis ID (108.1) in the Study record (107) points to related analysis of the study. Study Title (107.2) and Study description (107.3) are detailed information of the study. Categories for faceted classification (221) in study are used to categorize the study information, which will be used in faceted search.

An Analysis record (108) comprises fields for Analysis ID (108.1), Report ID (109.1), Study ID (107.1), Analysis Title (108.2), Analysis Description (108.3), Categories for faceted classification (221) and price (107.4). The Study ID (107.1) in Analysis record (108) is used to determine for which study the Analysis is performed. The Report ID (109.1) in Analysis record (108) points to related reports of the Analysis. Analysis Title (108.2) and Analysis Description (108.3) are detailed information of the analysis. Categories for faceted classification (221) in Analysis are used to categorize the analysis information, which will be used in faceted search.

A Report record (109) comprises fields for Report ID (109.1), Analysis ID (108.1), GeneData ID (219.1), Report title (109.2), Report description (109.3), and Categories for faceted classification (221). The Analysis ID (108.1) in the Report record points to related analysis of this Report. The GeneData ID (219.1) points to related GeneData in this report. Report title (109.2) and Report description (109.3) are detailed information of the report. Categories for faceted classification (221) in the report fields are used to categorize the report information, which will be used in the faceted search.

A GeneData (219) record comprises fields for GeneData ID (219.1), Categories for faceted search (221), Report ID (109.1), Gene ID (218.1), Gene Symbol (218.2), Rank (219.5), p-Value (219.3) and Fold change (219.4). The Report ID (109.1) in the GeneData field points to the related report of GeneData.

A Gene Record (218) comprises fields for Gene ID (218.1), Sponsorship ID (216.1), Advertisement ID (217.1), GeneData ID (219.1), Gene Symbol (218.2) and Gene title (218.3). The Sponsorship ID (216.1) in Gene record points to related Sponsorship of the gene. The Advertisement ID (217.1) in the Gene record points to related advertisement of the gene. The GeneData ID (219.1) in the Gene record points to related GeneData of the gene.

A Sponsorship Record (216) comprises fields for Sponsorship ID (216.1), Gene ID (218.1), Gene Symbol (218.2), Amount per Act (216.4), Amount per sponsorship (216.2), Total budget (for this sponsorship) (216.3) and Vender ID. The Gene ID (218.1) points to related gene of the Sponsorship.

An advertisement (217) includes Advertisement ID (217.1), Gene ID (218.1), Gene Symbol (218.2), advertisement title (217.2), Price per click (217.3) and Total Budget (217.4). The Gene ID (218.1) points to related gene of the advertisement.

In addition to these fields described, more fields can be added when required. As indicated in the input interfaces (FIG. 2A, 2B, 2C, 2D, 2E, 2F, 2G, 2H, 21, 2J), such fields include sample size, platform, number of platform, SKU, parent SKU, price, p-value, fold change, rank, publish date or author. The field for “sample size” describes the total sample in an experiment. The “platform” field comprises information on platform of high throughput technology. The field for “number of platform” is the number of high throughput technology used in an experiment. “SKU” is a unique label of the record. “Parent SKU” is the SKU of the information parent. A parent SKU of an analysis is the SKU of the study, from which the analysis derived. The “price” field comprises price information of a record. “Fold-change, Rank, p-value” fields describe the GeneData information.

The information of fields can be retrieve by providing an interface to a user. FIG. 2B exemplifies an interface to retrieve information of study. FIG. 2C exemplified an interface to retrieve information of analysis. FIG. 2D exemplifies an interface to retrieve information of report. FIG. 2E exemplifies an interface to retrieve information of GeneData.

Because the information is correlated, the information of study, analysis, report and GeneData can be displayed in a correlated way to a user. As exemplified in FIG. 2F, when a user views a study, study information will be presented to the user. In addition to the study information, the system will retrieve related analysis information based on the field (Analysis ID, 108.1) in the Study, and further retrieve related report information based on the field (Report ID, 109.1) in the Analysis. As a result, all related information is displayed in one webpage

Similarly, when a user views an Analysis, the system will retrieve related Report and Study information using Report ID (109.1) and Study ID (107.1) in the Analysis fields, as shown in FIG. 2G.

When a user views a Report, information of related Study, Analysis and Detailed Results (GeneData) can be retrieved and displayed together with the Report as in FIG. 2H.

When a user views a Detailed result (GeneData), information of related Study, Analysis and Report will be displayed as shown in FIG. 2I.

According to the embodiment, the categories of these records are controlled by a faceted classification system (221), which classifies each information element along multiple explicit dimensions. The categories (221) are designed to enable the classifications to be accessed and ordered in multiple ways. An exemplary embodiment of categories of faceted classification is shown in FIG. 2J. Catalog classifies the records by tissue type and disease. The Exp Type classifies the records by experimental design, such as diseased tissue vs normal, or treatment vs untreated. The report type classifies the records by the results types, including CNV (copy number variation), or LOH (loss of heterozygocity). The analysis type classifies the records by method of analysis. The Info type classifies the records by information levels, which comprises transcriptome, genome, and epigenome. The organism classifies the records by the organism of sample source.

The faceted classification (221) is used in faceted search, which is further exemplified in 4.5

4.3 An Exemplary Embodiment of Advertisement Module According to Present Invention

As exemplified in FIG. 2A, Records for GeneData and Advertisements (217) are correlated by Gene (218). Advertisement comprising a field (Gene ID, 218.1) pointing to related common name (Gene in this embodiment), and common name comprising a field (GeneData ID, 219.1) pointing to related GeneData. Similarly, GeneData comprising a field (Gene ID, 218.1) pointing to related common name (Gene, 218), and common name (Gene, 218) comprising a field (Advertisement ID, 217.1) pointing to advertisement.

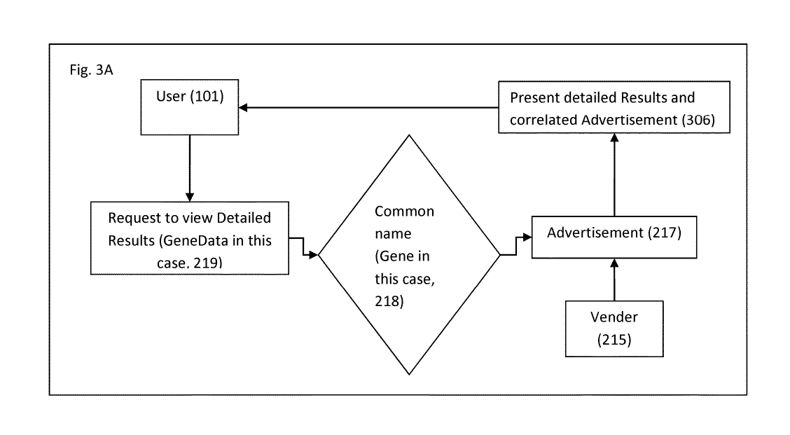

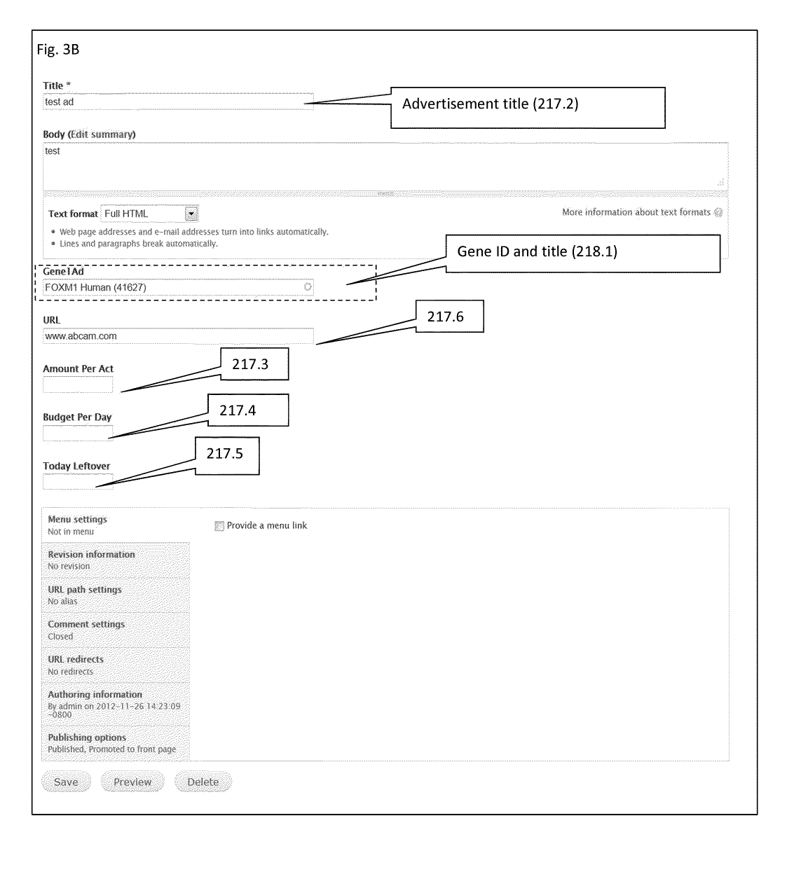

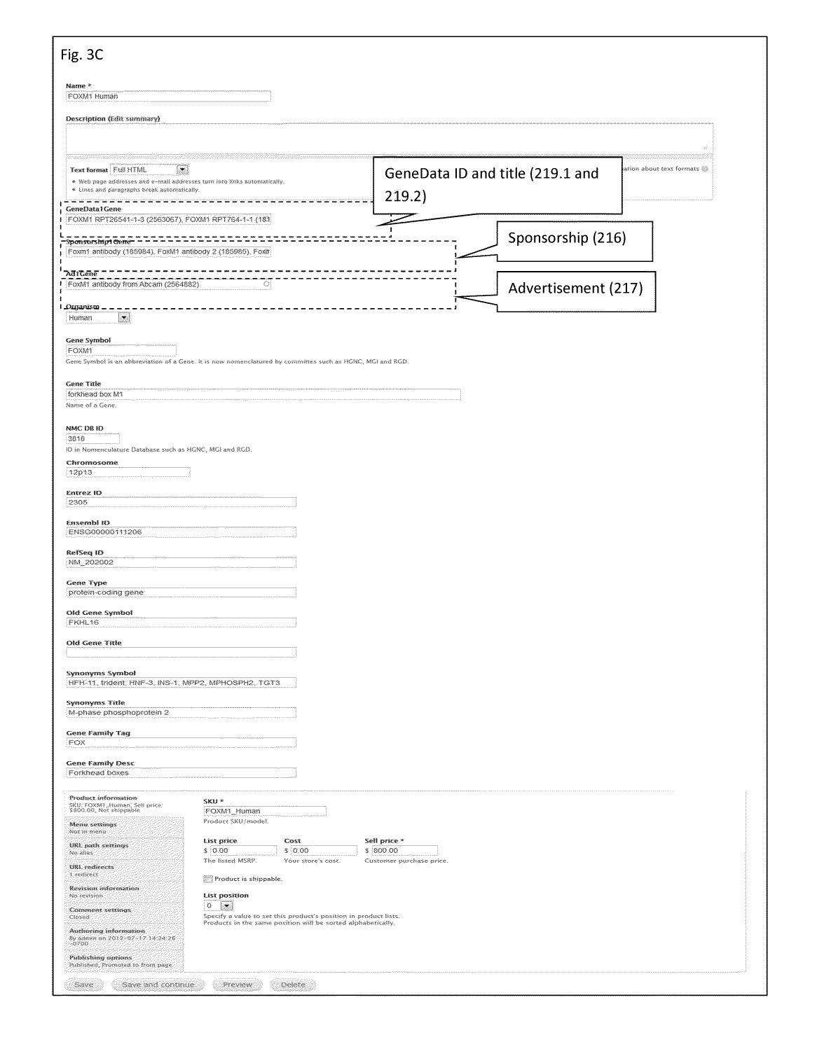

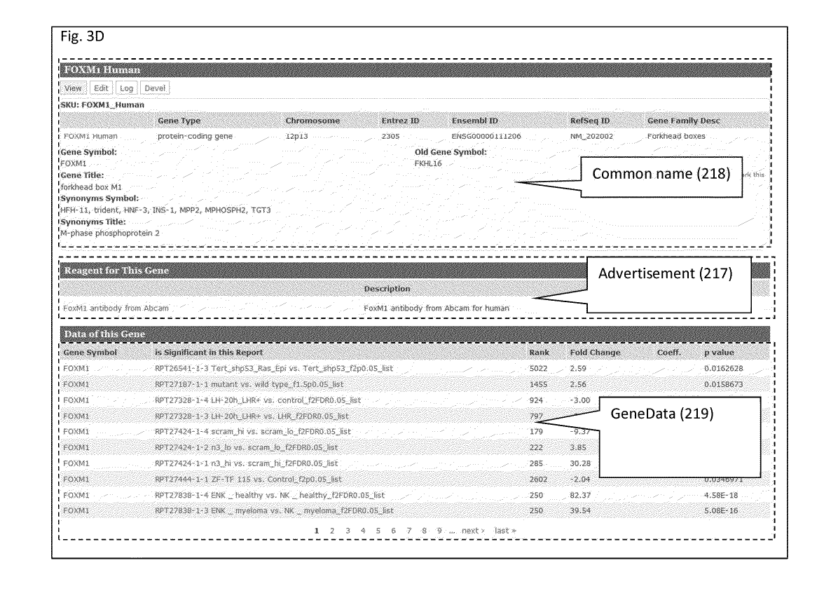

As further exemplified in FIG. 3A, the system allows a vender (215) to input advertisement (217) into the database and correlated the advertisement to Gene. The advertisement interface is exemplified in FIG. 3B, which retrieves advertisement information to be stored in the system database. The retrieved information include advertisement title, advertisement body, common name (218.1, also refer as Gene ID and title), advertisement URL (217.6), amount per act (217.3), budget per day (217.4) and today left over (217.5).

When a user (101) requests to view a record of experimental result (219), the system will invoke a Common name check module (301). The module will check the existence of advertisement (217) associated to a common name (Gene, 218) that is associated with the experimental result to be viewed. The requested Result and related Advertisements will be present to the user (101).

The information of amount per act (217.3), budget per day (217.4) and today left over (217.5) serves as pay-per-click advertisement. When a user clicks the advertisement, the system will deduct the “amount per act” from “today left over”. The amount of “today left over” is set to budget per day and will be reset in a predetermined period. Each click and correlated transaction may be stored in a database table for future justification of advertisement spending of an advertiser. The system can calculate valid clicks by predetermined criteria.

4.4 An Exemplary Embodiment of Sponsorship Module According to the Present Invention.

As exemplified in FIG. 2A, Records for GeneData (219) and Sponsorships (216) are correlated by Gene (218). Sponsorship comprising a field (Gene ID, 218.1) pointing to related common name (Gene in this embodiment), and common name comprising a field (GeneData ID, 219.1) pointing to related GeneData (219). Similarly, GeneData (219) comprising a field (Gene ID, 218.1) pointing to related common name (218), and common name (218) comprising a field (Sponsorship ID, 217.1) pointing to related Sponsorship (216).

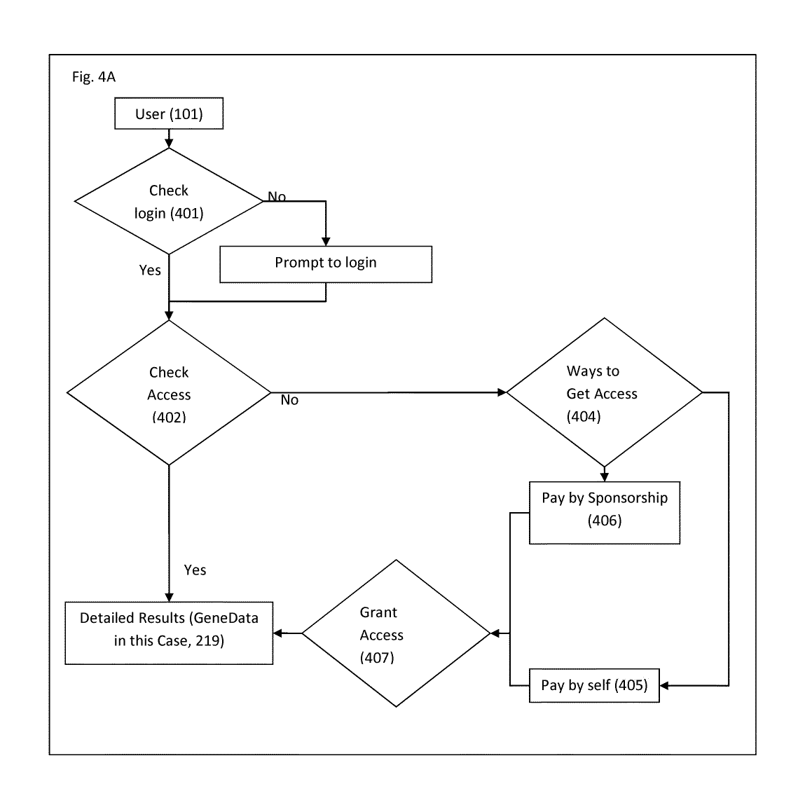

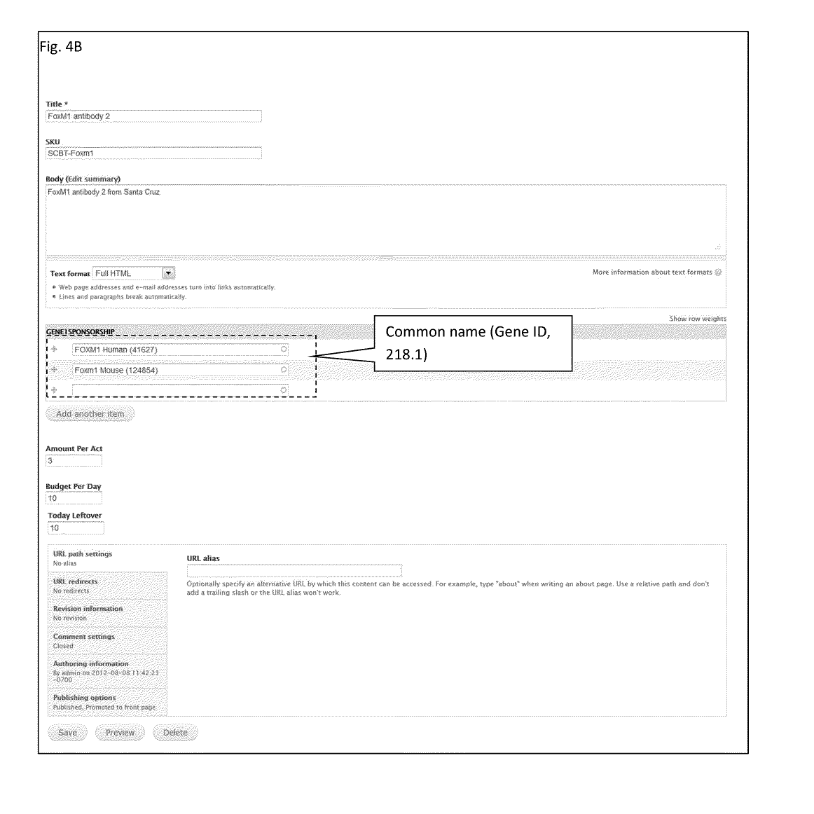

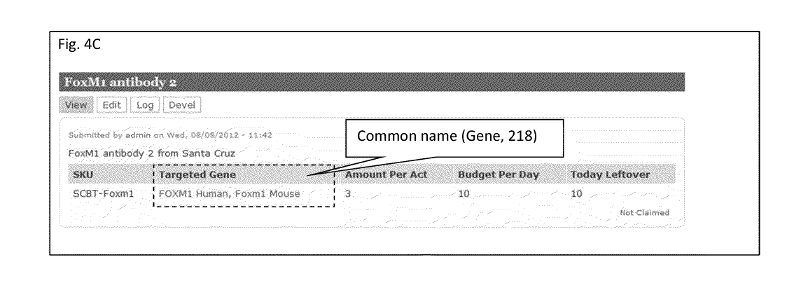

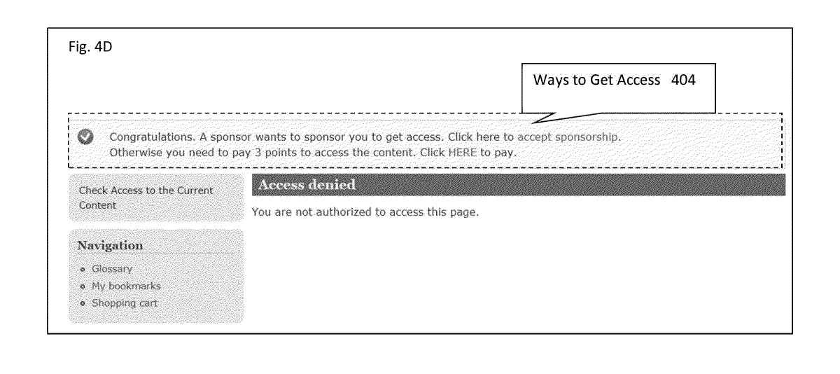

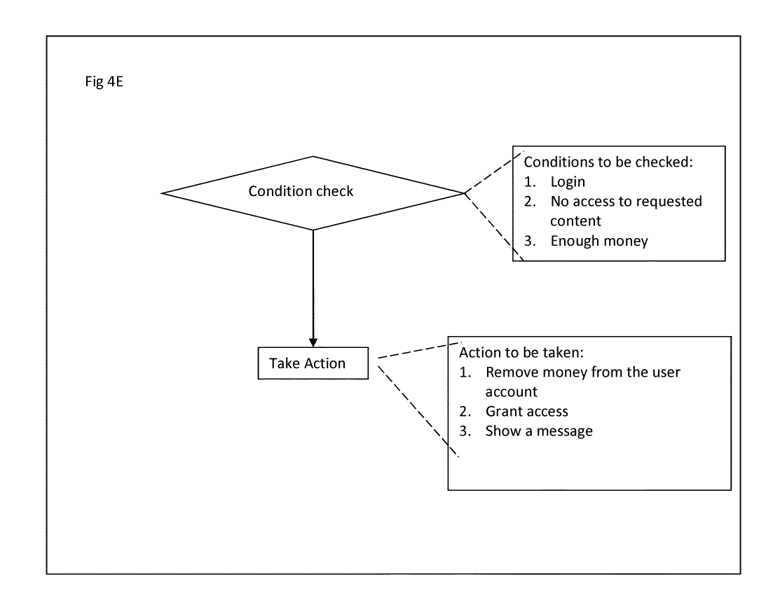

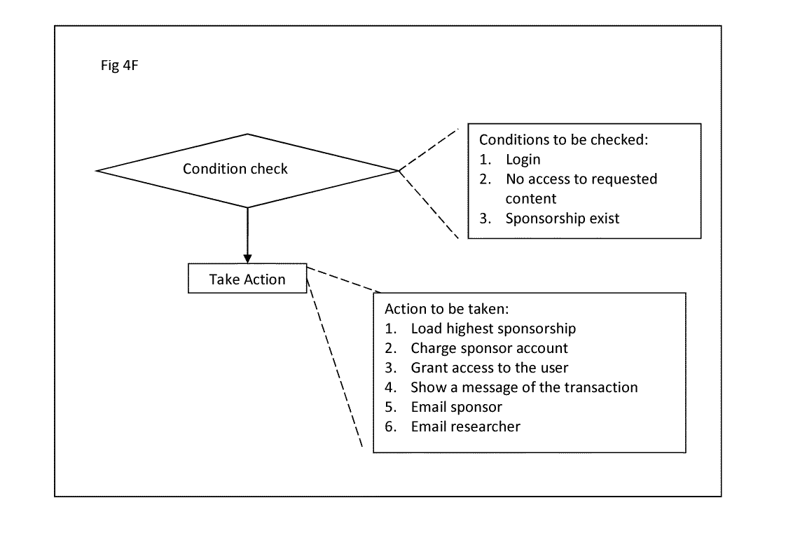

The embodiment in FIG. 4A further exemplifies the implement of present sponsorship (216) to a researcher (101). According to the embodiment in FIG. 2, the fields of the records allow a vender (215) to input sponsorship information (216) and correlated the sponsorship to Common Names (Gene, 218), which are eventually related to certain Experimental Results (219) that share the same common name (Gene, 218).

The sponsorship input interface is exemplified in FIG. 4B, which retrieve sponsorship information to be stored into database. The retrieved information include Sponsorship title, Sponsorship description, common name (218.1, also refer as Gene ID and title), amount per act (217.3), budget per day (217.4) and today left over (217.5).

According to the preferred embodiment (FIG. 4A), the user will have to use a prepaid account to use the functions. When a user (researcher) views an Experimental Result (219) (GeneData record in this embodiment, the system will invoke a Check Access (402) module and check whether user has access to the Result (GeneData). If the user does have access, the system will directly present user the requested information (219). If the user does not have access to the result, the system will invoke Ways to Get Access module (404), which allow user to choose either Pay by self (405), which subsequently present user an interface to pay to gain access; or Pay by Sponsor (406), which will query Common Names (218) to find related Sponsorships (216). If the common name (218) in the result has a Sponsorship (216) correlated, certain money will be deducted from a Sponsor pre-paid account and access will be granted (407) to the user. As a reward to the Sponsor, the sponsored user (here is the researcher) information is provided to the Sponsor. As user who requests to view the result (GeneData) information is a potential buyer for certain Common Name (Gene, 218) related products. In this embodiment, the gene related products comprise antibodies, siRNAs, primers and plasmids. The Sponsor can contact the user to promote these products. To allow instant transaction, the sponsor is requested to pre-deposit certain amount of money into its account in the system.

An exemplary embodiment of Pay by Self module is shown in FIG. 4E. When a user selects Pay by Self, the system will first perform a condition check to make sure the predetermined conditions are met. In the present embodiment, the system requires three conditions (1, the user is logged in; 2, the user do not have access to the requested content; 3, the user has enough money in its prepaid account). If these conditions are all met, the system will trigger predetermined actions. In the present embodiment, the actions are 1, remove money from the user account; 2) grant access to the user; and 3) show a message to the user of the transaction.

An exemplary embodiment of Pay by Sponsor module is shown in FIG. 4F. When a user selects Pay by Sponsor (accept sponsorship), the system will first do a condition check to make sure all predetermined conditions are met. In the present embodiment, the system requires three conditions: 1, the user is logged in; 2) the user does not have access to the requested content; 3) the sponsorship for the requested content exists. If these conditions are all met, the system will trigger predetermined actions. In the present embodiment, the actions are 1) load highest sponsorship if there are multiple sponsorships and determine sponsor; 2) remove money from the sponsor account; 3) grant access to the user; 4) display a message of the transaction; 5) email sponsor the transaction; 6) email the user the transaction.

4.5 An Exemplary Embodiment of Faceted Search System According to the Present Invention.

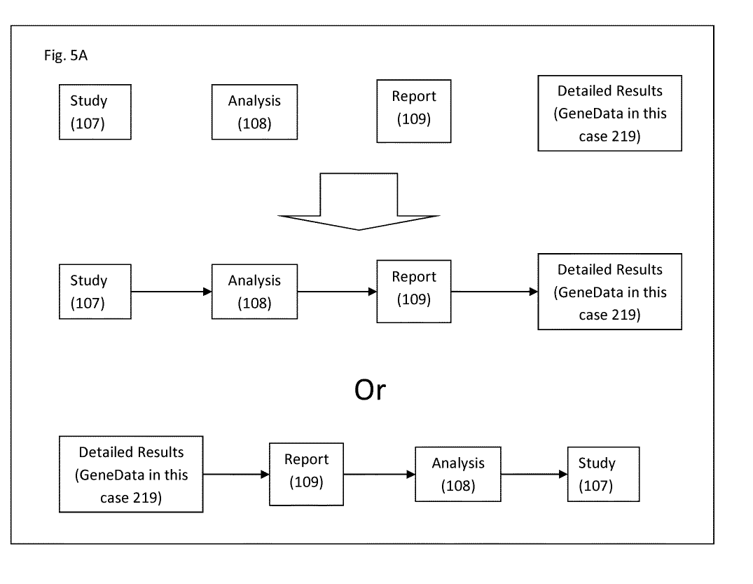

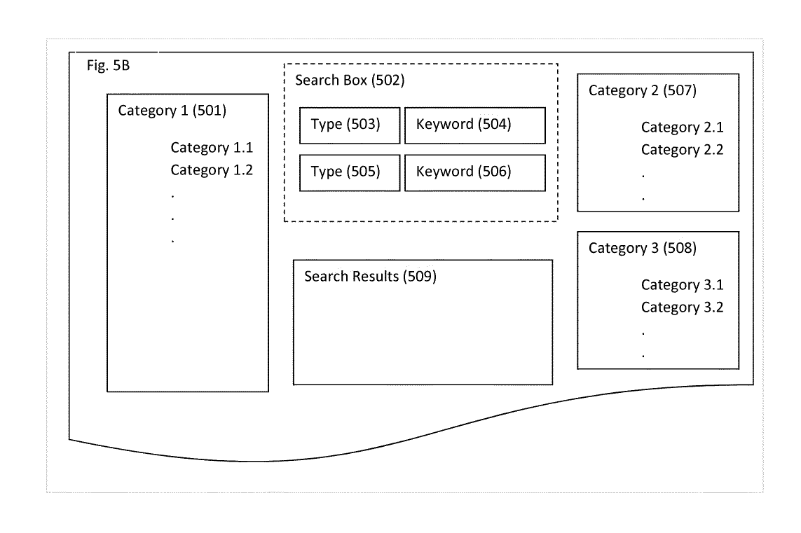

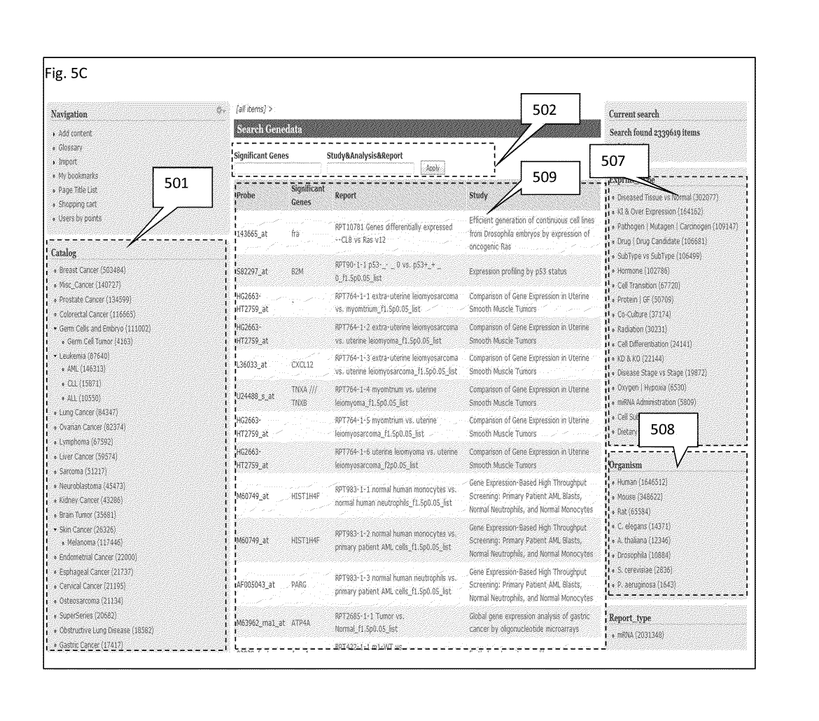

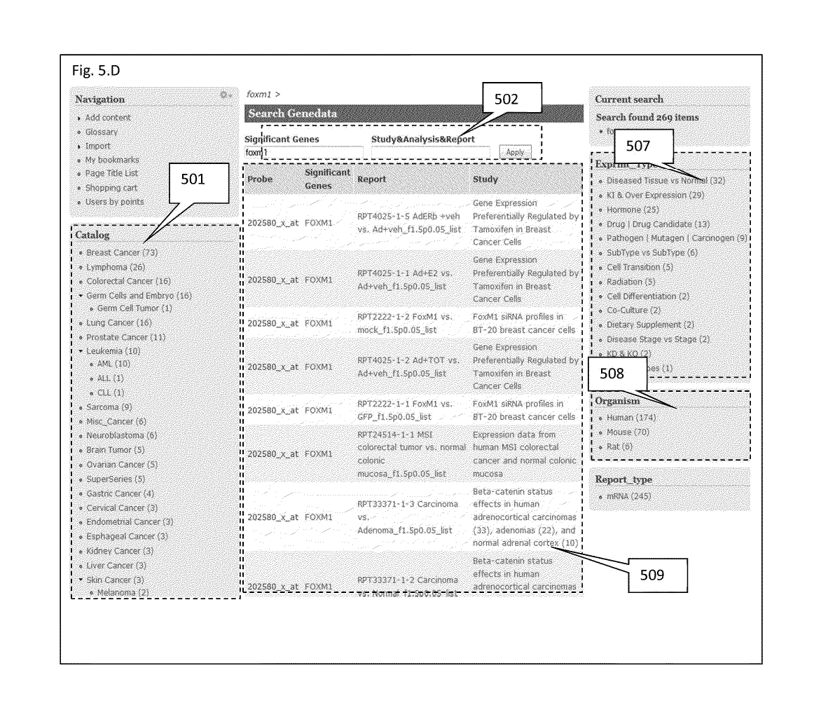

As exemplified in FIG. 5A, the study, analysis, report and detailed results are indexed in two different ways. One is indexed from study to detailed results. The other is indexed from detailed results to study. Both indexes use the correlating fields in the study, analysis, report and detailed results to integrate the related information into one big table. When the database records are indexed in such way, faceted classification are shared between study, analysis, report and detailed results. For example, detailed results are classified using categories in study, which comprising analysis type, catalog and report type.

The system provides a faceted search interface for user to search information in different type of contents. The faceted search takes advantage of the faceted classification that has been exemplified in 4.2. The options of content to be searched comprise Study, Analysis, Report, Detailed Results (GeneData in this embodiment) and Common Names (Gene Symbol in this embodiment).

According to the embodiments (FIG. 5B), the interface present information of 3 categories, Category 1 (501), Category 2 (502) and Category 3 (503), each may further contain several sub-categories. A search box (502) will be presented to user to collect search criteria. User can select type of content to search (503, 505) and input keyword (504, 506). The search results will be displayed in 509. The interactive interface will be able to update the information in each category according to search criteria. FIGS. 5C and 5D exemplify a faceted search interface for Detailed Results (GeneData) using an index structure GeneData→Report→Analysis→Study. The faceted classification system in Study is used to classify the indexed records. It is to be understood that the faceted search system may be advantageous by implementing search engine server such as Apache SoIR (http://lucene.apache.org/solr/).

A system according to the invention has been made accessible through the World Wide Web with a URL of hftp://www.esophageal-cancer.org

The system has been described with reference to a preferred embodiment particularly suited for managing and searching for results derived from high throughput biological experiments. It is to be understood that the system according to the invention is suitable for other applications including the management of other types of high throughput studies.

It is to be understood that the system is not limited to using the physical file, record and field structures described herein and other physical structures which are logically equivalent will be equivalent for the purpose of this invention.

### SUMMARY OF THE INVENTION

While the invention has been described and shown in connection with the preferred embodiment, it is to be understood that modifications may be made without departing from the spirit thereof. The embodiment described is by way of example and should not be construed as limiting of the claims except where referenced to the specification is required for such construction. The claims below are set forth to define the scope of protection sought by this application.

I claim:

1. A web-based data managing system from high throughput experiments, comprising
a communication port suitable for transmitting and receiving data and instructions in the form of electrical signals, to and from remote computers or equipments
a database suitable to store information derived from high-throughput experiments, comprising information of studies, analyses and reports, with each analysis associated with a corresponding study and each report associated with a corresponding analysis.
a database manager for creating and revising records of databases connected to the said electronically readable memory responsive to a plurality of said remote computers.
an interactive database query engine connected to said memory, said engine configured to permit an initial search and at least one subsequent search where said subsequent search operates on the results of said first search and any previous search.
a process controller, connected to the said database manager, said iterative database query engine and said communication port;

2. the said reports in claim 1, further comprise a report summary and a list of experimental results of detections derived from the said corresponding analysis;

3. the said system in claim 1, further comprises web interfaces to retrieve information from the said database and present the information to a user;

4. the system in claim 1, further include a faceted search system, comprising a) a faceted classification system to categorize the information derived from the said high-throughput experiments; b) a faceted search-interface to search and display the categorized information;

5. in claim 4 wherein said a faceted classification system to categorize the information of the said studies, analyses and reports, the categories comprise research fields, study types, analysis types and experimental sample types.

6. In claim 4 wherein said the faceted search-interface, is a webpage, comprising a) a central space of the said webpage to display search results; b) at least one input space to input search criteria; c) at least one space to display information of categories.

7. the system in claim 1, further include a advertising system, comprising a) a common name system to unify detections in the said reports into common names and associate each detection with a corresponding common name; b) a module to allow advertiser to input advertisement information and associate the advertisement information with one or multiple selected common names; c) an interface to present a user a detection result and an advertisement which is associated to the detection results through a common name.

8. the system in claim 7, wherein said common name, comprising names for gene symbols, metabolites, chemicals and means for human readable names of experimental results of detections.

9. the system in claim 1, further include a access control system, comprising a) a module to put information into a accessing controlling pool; b) a module to grant a user the access to the information at a predetermined condition;

10. the system in claim 9, wherein said the predetermined condition, comprising one of the follows: a) a sponsor set a sponsorship and associate the sponsorship to experimental results through common names; a user is presented an option to receive a sponsorship when trying to access an experimental result; the user accept the sponsorship; b) a price is set for each individual result; a user pays the amount of price;

11. A marketing method, comprising
providing an interface to allow a user to input information;
storing the information into an online database and putting the information into an access control pool;
providing an interface to allow a sponsor to 1) input sponsorship information and 2) associate the sponsorship to the access restricted information;
storing the sponsorship information and the association into an online database;
at predetermined condition, granting access permission to a user, charging sponsor, and inform the related parties of the transaction.

12. in claim 11, wherein said to associate the sponsorship to the access restricted information, the sponsorship was associated to the access restricted information through common names, which comprising names for gene symbols, metabolites, chemicals and means for human readable names of experimental results of detections.

13. in claim 11, wherein said pre-determined condition, comprising 1) presenting an interface to allow the said user to accept or reject the sponsorship offer; 2) the said user accept the sponsorship offer.

14. in claim 11, wherein said sponsorship information, comprising the amount of each sponsorship, the amount of the budget for each day and title of the sponsorship.

15. A advertising method, comprising providing an interface to retrieve information of analysis result of detections;
storing the information into an online database;
unifying the detections into common names and associating each detection to corresponding common name;
providing an interface to retrieve advertisement information from an advertiser and associate the advertisement information with the common names;
storing the advertisement information and association into a online database;
at predetermined condition, presenting the detection results and the associated advertisement to a user

16. the said pre-determined condition in claim 15, is when the said user visits the said analysis result of the said detection.

17. the said common names in claim 15, comprising names for gene symbols, metabolites, chemicals and means for human readable names of experimental results of detections.
